(19) United States
(12) Patent Application Publication
(10) Pub. No.: US 2010/0242054 A1
(43) Pub. Date: Sep. 23, 2010

(54) METHOD AND APPARATUS FOR INSTALLING PRINTER DRIVER

(75) Inventors: YI-FANG WU, Tu-Cheng (TW); SHI-YUN YU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HON HAI PRECISION INDUSTRY CO., LTD., Tu-Cheng (TW); HONG FU JIN PRECISION INDUSTRY (ShenZhen) Co., LTD, Shenzhen City (CN)

(21) Appl. No.: 12/551,704

(22) Filed: Sep. 1, 2009

(30) Foreign Application Priority Data
Mar. 18, 2009 (CN) 200910300946.9

(51) Int. Cl. G06F 9/445; G06F 15/00

(52) U.S. Cl. 719/321; 358/1.15

(57) ABSTRACT

A method for installing a printer driver for a terminal, includes providing a driver installation apparatus that includes a control module, a communication module, and a storage module in which a plurality of printer driver files are stored. The control module scans the terminal, and checks if there is any printer connected to the terminal. When there is a printer connected to the terminal, the control module scans the model of the printer, and searches corresponding printer driver file according to the model of the printer in the storage module. The control module runs the printer driver file, and installs the corresponding printer driver in the terminal.

### BACKGROUND

1. Technical Field

The present embodiment relates to method and apparatus for mounting driver, and particularly to a method and apparatus for mounting a printer driver.

2. Description of Related Art

Conventionally, for printing, a printer is needed, and a terminal, which is installed with a driver of the printer, sends files to the printer to print. However, if there is a plurality of terminals having the requirement of file print, the printer driver should be installed in each of the terminals. It is a burden to install printer drivers in so many terminals. Additionally, when some portable terminals, such as laptop computers, smart phones, and so on, are moved to a new work environment, these portable terminals often need to connect to a new printer, which means yet another installation of a driver for the new printer.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an apparatus for installing printer drivers; and

FIG. 2 is a flowchart of a method for installing printer drivers.

### DETAILED DESCRIPTION

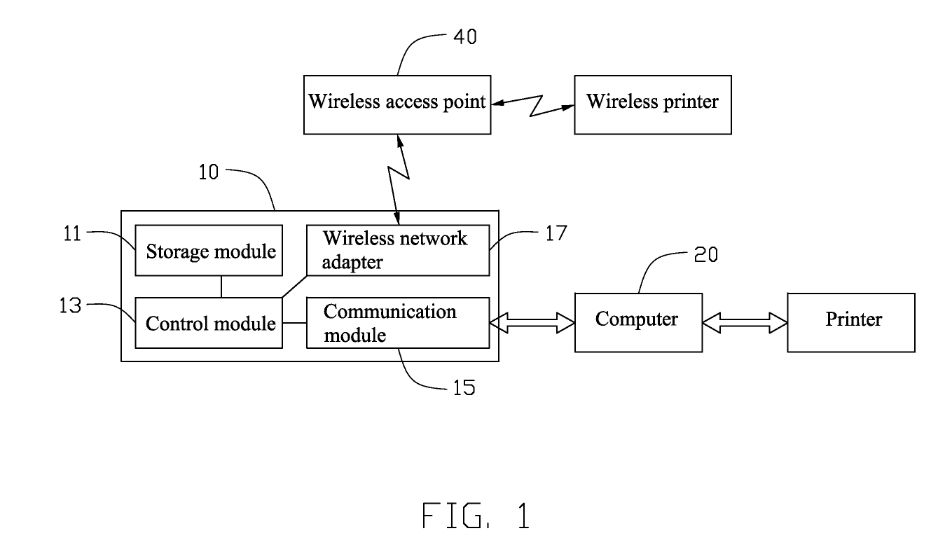

Referring to FIG. 1, a driver installation apparatus 10 is used to install printer drivers for different terminals, such as laptop computers, and smart phones, for example. The driver installation apparatus 10 includes a storage module 11, a control module 13, a communication module 15, and a wireless network adapter 17. The control module 13 is connected to the storage module 11, the communication module 15, and the wireless network adapter 17.

A plurality of printer driver files are stored in the storage module 11. These printer driver files correspond to different kinds of printers and different operating systems (such as Windows operating system, Linux operating system, and so on). The storage module 11 further stores a printer driver file list. The driver list records a plurality of information, such as a name of each printer driver file stored in the storage module 11, models of accommodating printers of each printer driver file, a storage path of each printer driver file, accommodating operating systems of each printer driver file.

The communication module 15 is used to communicate with different terminals in which a printer driver needs to be installed. In the embodiment, the communication module 15 communicates with the terminals via a USB port. The wireless network adapter 17 is used to connect to a wireless access point 40, thereby able to search for printers in a wireless network. Further, the wireless network adapter 17 can connect to the Internet via the access point 40.

When the driver installation apparatus 10 is utilized, a terminal, such as a computer 20, is connected to the communication module 15 via the USB port. Then, the control module 13 of the driver installation apparatus 10 is capable of scanning the computer 20, and the computer 20 is capable of searching for a wireless printer via the wireless network adapter 17 of the driver installation apparatus 10.

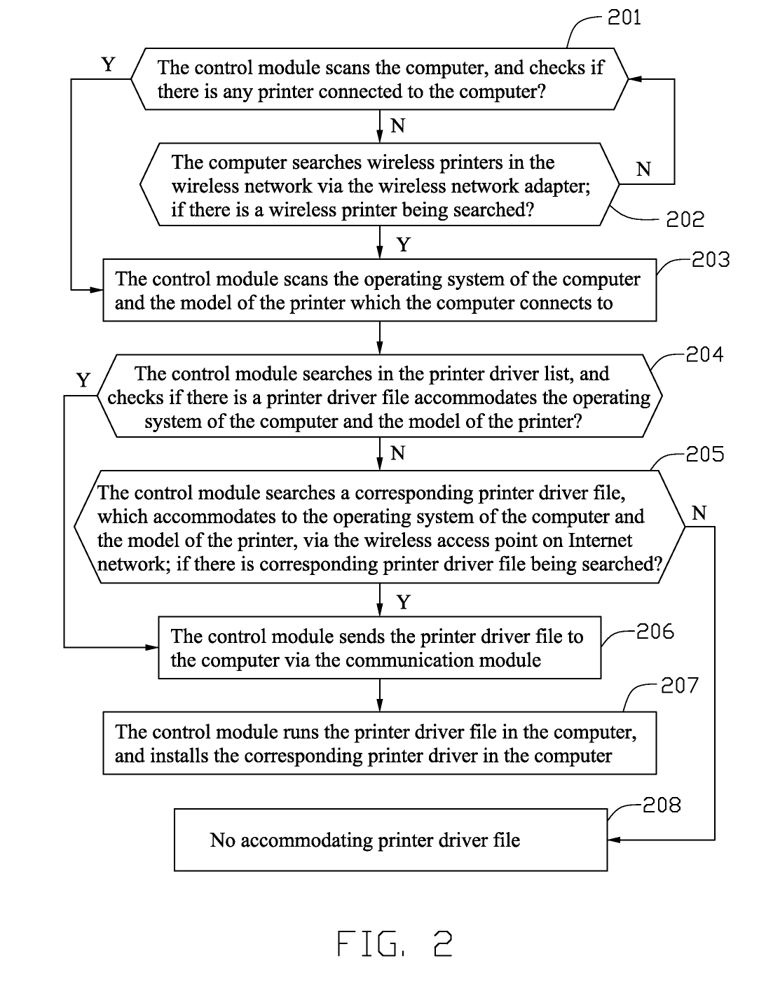

Referring to FIGS. 1 and 2, after the computer 20 is connected to the driver installation apparatus 10, a method for the driver installation apparatus 10 to install a printer driver in the computer 20 is described below.

In step 201, the control module 13 of the driver installation apparatus 10 scans the computer 20, and checks if there is any printer connected to the computer; if there is, go to step 203; if there is not, go to step 202.

In step 202, the computer 20 searches for wireless printers in the wireless network via the wireless network adapter 17 and the wireless access point 40; if a wireless printer is found, the computer 20 connects to the wireless network adapter 17, and then go to step 203; if there is not a wireless printer found, go back to step 201.

In step 203, the control module 13 scans the computer 20 to determine the operating system being used and the model of the printer which the computer 20 connects to; then go to step 204.

In step 204, the control module 13 searches in the printer driver list, and checks if there is a printer driver file which accommodates the operating system of the computer 20 and the model of the printer; if there is, go to step 206; if there is not, go to step 205.

In step 205, the control module 13 searches for a printer driver file, which accommodates to the operating system of the computer 20 and the model of the printer, on the Internet via the wireless access point 40; if the corresponding printer driver file is found, the printer driver file is downloaded and stored in the storage module 11, then go to step 206; if the corresponding printer drive is not found, then go to step 208.

In step 206, the control module 13 sends the printer driver file to the computer 20 via the communication module 15; then go to step 207.

In step 207, the control module 13 runs the printer driver file in the computer 20, and installs the corresponding printer driver in the computer 20.

In step 208, the control module 13 notifies the computer 20 that there is no accommodating printer driver file.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for installing a printer driver in a terminal, comprising:
providing a driver installation apparatus, comprising a control module and a storage module in which a plurality of printer driver files are stored;
using the control module to scan the terminal, and check if there is any printer connected to the terminal;
in response to a printer being connected to the terminal, the control module scans the model of the printer, and searches corresponding printer driver file in the storage module according to the model of the printer; and
using the control module to run the corresponding printer driver file, and install the corresponding printer driver in the terminal.

2. The method of claim 1, wherein the driver installation apparatus comprises a wireless network adapter, when there is not a printer connected to the terminal, the terminal searches wireless printers in wireless network via the wireless network adapter.

3. The method of claim 2, wherein if there is not corresponding printer driver file being searched in the storage module, the control module further searches the corresponding printer driver file on Internet via the wireless network adapter.

4. The method of claim 3, wherein if there is not corresponding printer driver file being searched in the storage module and Internet, the control module notifies the terminal that there is no accommodating printer driver file.

5. The method of claim 1, wherein a printer driver file list is stored in the storage module, information in the list comprises name of each printer driver file stored in the storage media, models of accommodating printers of each printer driver file, the corresponding printer drive file is searched via the list.

6. The method of claim 5, wherein information in the list further comprises an accommodating operating system of each printer driver file, and wherein the control module also scans the operating system of the terminal, and searches corresponding printer driver file also according to the operating system of the terminal.

7. A driver installation apparatus for installing a printer driver in a terminal, comprising:
a storage module storing a plurality of printer driver files therein;
a control module scanning a model of a printer which is connected to the terminal, wherein the control terminal is capable of searching corresponding printer driver file according to the model of the printer in the storage module, and running the printer driver file to install corresponding printer driver in the terminal.

8. The driver installation apparatus of claim 7, further comprises a wireless network adapter via which the control module searches the corresponding printer driver file on Internet when there is not corresponding printer driver file in the storage module.

9. The driver installation apparatus of claim 8, wherein the terminal is capable of connecting to a wireless printer via the wireless network adapter.

10. The driver installation apparatus of claim 7, wherein a printer driver file list is stored in the storage module, information in the list comprises name of each printer driver file stored in the storage media, models of accommodating printers of each printer driver file, the corresponding printer drive file is searched via the list.

11. The driver installation apparatus of claim 10, wherein information in the list further comprises accommodating operating system of each printer driver file, the control module also scans the operating system of the terminal, and searches corresponding printer driver file also according to the operating system of the terminal.
